(19) United States
(12) Patent Application Publication
(10) Pub. No.: US 2004/0084275 A1
(43) Pub. Date: May 6, 2004

(54) Friction clutch

(75) Inventors: Andreas Orlamunder, Schweinfurt (DE); Olaf Pagels, Bergrheinfeld (DE); Christoph Kleuker, Gochsheim (DE); Markus Heiartz, Wurzburg (DE); Sebastian Vogt, Bad Neustadt (DE)

Correspondence Address: COHEN, PONTANI, LIEBERMAN & PAVANE, 551 FIFTH AVENUE, SUITE 1210, NEW YORK, NY, 10176, US

(73) Assignee: ZF Sachs AG

(21) Appl. No.: 10/616,714

(22) Filed: Jul. 10, 2003

(30) Foreign Application Priority Data
Jul. 12, 2002 (DE) 102 31 493.4
Aug. 10, 2002 (DE) 102 36 806.6

(51) Int. Cl. F16D 13/50

(52) U.S. Cl. 192/70.27; 192/110 B

(57) ABSTRACT

A friction clutch includes a housing having an axis of rotation; a pressure plate connected to the housing for rotation in common; a force exerting arrangement supported against the housing and the pressure plate; an actuator mechanism which acts on the force exerting arrangement to load the pressure plate axially with respect to the housing; and a bearing arrangement for supporting the actuator mechanism axially with respect to the housing so that it is prevented from moving in either axial direction.

### BACKGROUND OF THE INVENTION

1. Field of the Invention

The present invention relates to a friction clutch, that includes a pressure plate connected to a housing arrangement for rotation in common around an axis of rotation and a force-exerting arrangement supported against the pressure plate and the housing arrangement.

2. Description of the Related Art

In these types of friction clutches, the forces and the forces of reaction produced during actuation processes are transmitted to the bearings of a drive shaft such as, for example, to the crankshaft bearings, unless internal support is provided in the friction clutch itself. In the case of conventional clutches, in which energy-storing devices are used as force-exerting arrangements and the actuating processes leading to the forces in question are clutch-release processes, the loads exerted on the crankshaft bearings are comparatively short in duration. In the case of clutches which are kept engaged by the production of a continuous engaging force, however, the forces are present practically during the entire time that the clutch is operating. This leads to a nearly continuous axial load on the crankshaft bearings, which are usually not designed to handle such loads.

It is therefore possible to design the clutch so that the forces of reaction which are produced upon the execution of actuating processes are absorbed by the clutch itself. For this purpose, a bearing arrangement can be provided, which disconnects certain components so that they no longer rotate in common and thus allows the housing arrangement to absorb the forces.

### SUMMARY OF THE INVENTION

It is the object of the present invention to provide a friction clutch which guarantees that the various system components are kept precisely in their proper positions with respect to each other while at the same time providing for the internal absorption of the forces.

According to the invention, a friction clutch includes at least one pressure plate, which is connected to a housing arrangement for rotation in common around an axis of rotation; a force-exerting arrangement, which is supported against the pressure plate and the housing arrangement; and a bearing arrangement on the housing arrangement to absorb the forces of reaction, these being the forces which are produced in an actuator system upon the execution of actuating processes, where the bearing arrangement is supported with respect to the housing arrangement in such a way that it is prevented from moving in either axial direction.

Because the bearing arrangement is supported in both axial directions, it is guaranteed that a defined end position is produced not only in the direction in which a force is exerted between the bearing arrangement and the housing arrangement upon execution of actuating processes, but also in the other direction, this being advantageous especially upon the execution of installation processes for installing the components in their proper positions without play.

In the friction clutch according to the invention, for example, it is possible for the housing arrangement to cooperate with a retaining element to form an opening, which serves to accept a locking element. The locking element supports the bearing arrangement in one axial direction. So that the fewest possible components must be made available to realize the principles of the invention, it is also possible for the retaining element to support the bearing arrangement in the other axial direction. As an alternative, it is also possible to form a support section on the housing arrangement to support the bearing arrangement in the other axial direction.

In an alternative, very easy-to-implement method for holding the bearing arrangement in place in both axial directions, it is possible for the bearing arrangement to be supported on the housing arrangement in both axial directions by a plurality of pin-like support elements.

According to another alternative design, it is possible for a thread to be formed on a bearing component of the bearing arrangement, which thread engages with a thread formed on the housing arrangement.

According to another alternative design, a first retaining element, which supports the bearing arrangement in a first axial direction, is attached to the housing arrangement, and a second retaining element, which supports the bearing arrangement in a second axial direction, is attached to the bearing arrangement It is possible to arrive at a very simple-to-produce connection again by providing one of the retaining elements with a thread, which engages with a thread on the housing arrangement. It is also possible for one of the retaining elements to be attached to the housing arrangement by a latching type of connection. In this case, it is possible, for example, for one of the retaining elements to have retaining tongues, which grip the other retaining element.

The bearing arrangement can include, for example, a sliding bearing arrangement, where a first sliding bearing element is supported axially on a first retaining element, and a second sliding bearing element is supported axially on a second retaining element. At least one of these sliding bearing elements can simultaneously have a radial support area for the purpose of radial centering. The sliding bearing can run wet or dry; if it runs wet, a seal can be provided. If a wet-running sliding bearing arrangement is used, a sealing arrangement can preferably be provided to encapsulate the bearing arrangement in an essentially lubricant-tight manner. It is therefore possible to supply lubricant to the area of the surfaces which are in frictional contact with each other via one of the components to be supported, so that a very low-friction support can be achieved and so that simultaneously a sealing function at least effective enough to prevent all but slight leaks can be obtained by means of the sealing arrangement.

In another alternative embodiment of the invention, a locking element is provided on the bearing arrangement; the housing arrangement is supported on a first axial side of the locking element; and a retaining element, which is permanently connected axially to the housing arrangement, is supported axially on a second axial side of the locking element. The retaining element can be permanently connected to the housing arrangement by riveting, welding, brazing, bonding with an adhesive, deforming, press-fitting, etc.

In another alternative embodiment, the bearing arrangement is supported on an insert element in both axial directions and the insert element is permanently attached or capable of being permanently attached to the housing arrangement. The insert element can have an axial stop for the support of the bearing arrangement in a first axial direction and can have a locking element for supporting the bearing arrangement in the second axial direction.

The friction clutch according to the present invention can be designed as a dual clutch with a first clutch area and a second clutch area, each comprising a pressure plate and a force-exerting arrangement. In this case, it is possible for each of the two, clutch areas to have its own actuation system, which is connected to the housing arrangement in the manner specified according to the present invention and which therefore ensures that the actuating forces are absorbed within the clutch itself. Of course, it should also be pointed out that the friction clutch according to the present invention can also be a conventional single-disk clutch or multi-disk clutch for which only a single actuator system is required.

Other objects and features of the present invention will become apparent from the following detailed description considered,in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

FIG. 1 is a partial longitudinal cross-sectional view through a friction clutch according to the present invention;

FIG. 2 is a detailed view of a bearing arrangement on a housing of the friction clutch shown in FIG. 1;

FIGS. 3-10 are detailed views, corresponding to FIG. 2, of alternative embodiments of the connection;

FIG. 11 shows a modification of the embodiment shown in FIG. 10;

FIG. 12 shows a modification of the embodiment shown in FIG. 10;

FIG. 13 shows a modification of the embodiment shown in FIG. 10;

FIG. 14 is a detailed view, corresponding to FIG. 2, of an alternative embodiment;

FIG. 15 is a detailed cross-sectional view of the connection of a bearing arrangement, which is designed here as a sliding bearing arrangement; and

FIG. 16 shows a modification of the embodiment-according to FIG. 15.

### DETAILED DESCRIPTION OF THE PRESENTLY PREFERRED EMBODIMENTS

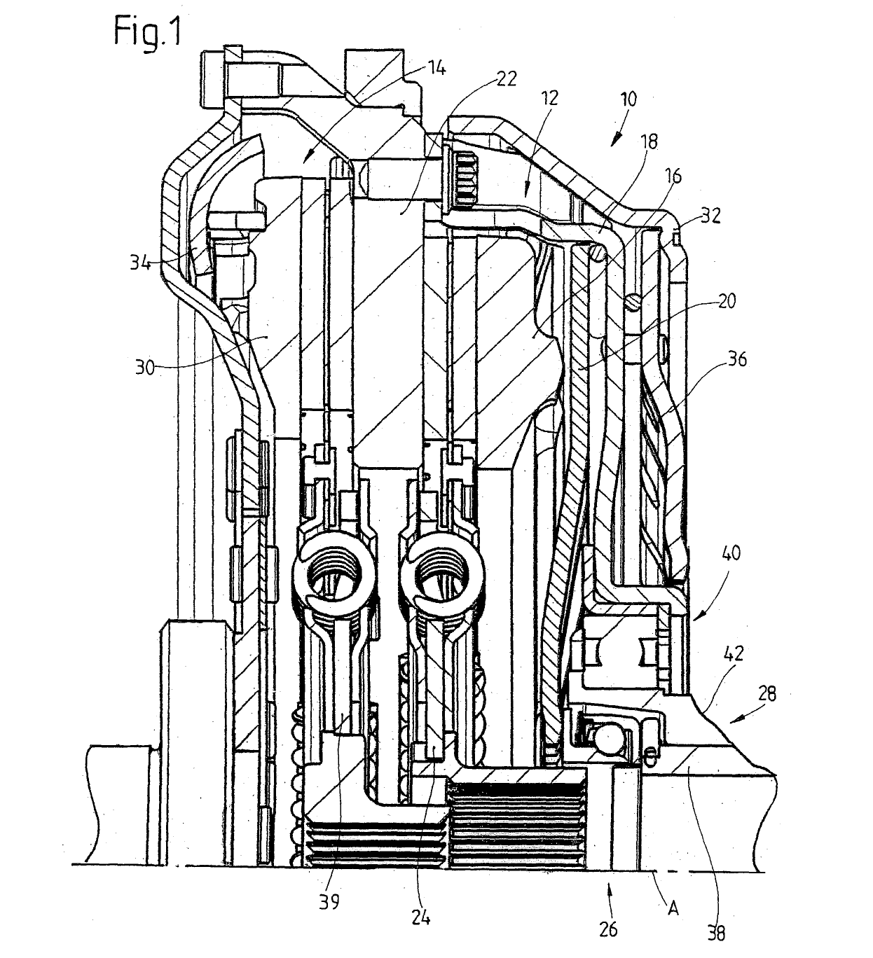

In FIG. 1, a friction clutch 10 is dual clutch having two clutch areas 12, 14. The first clutch area 12 has a pressure plate 16, which is mounted non-rotatably in a housing arrangement 18, but which has a certain freedom of movement in the direction parallel to an axis of rotation A. The pressure plate 16 can be pushed toward an intermediate plate 22 by a force-exerting arrangement 20, the radially outer area of which is supported on the housing arrangement 18, with the result that the friction linings of a clutch disk 24 are clamped between the pressure plate 16 and the intermediate plate 22. The force-exerting arrangement 20 can comprise several lever elements, which are arranged in the circumferential direction around the axis of rotation and which extend essentially in the radial direction. The lever elements can be connected to each other and can be acted upon in the radially inner area by an actuating mechanism 28, which acts by way of an actuating bearing 26. An energy-storing device such as a diaphragm spring could also be used as the force-exerting arrangement 20, which, in the case of a clutch of the push type, can also be acted upon in the inner area by way of the bearing 26, like the lever elements, to be moved toward the pressure plate 16 to engage the clutch.

The clutch area 14 comprises a clutch disk 30, which can be pretensioned toward the intermediate plate 22 by two housing-like or shell-like force-transmission elements 32, 34, which are connected to each other by connecting elements (not shown); and by an additional force-exerting arrangement 36, which is supported on the external surface of the housing arrangement 18. The friction linings of a clutch disk 39 can then be clamped between the pressure plate 30 and the intermediate plate 22. An actuating mechanism can be assigned in the same way to the second clutch area 14, i.e., to the force-exerting arrangement 36 of that area. The force-exerting arrangement 36 can also comprise several lever elements, which are arranged around the circumference and possibly connected to each other, and which, upon appropriate excitation of the actuating mechanism, transmit a clutch-engaging force. An energy-storing device which exerts a pretensioning force in the clutch-engaging direction can also be used.

The actuator mechanism 28 shown in FIG. 1 is supported in the area of a first actuator component 38 by the previously mentioned bearing 26 on the force-exerting arrangement 20. A second actuator component 42 is supported with respect to the housing arrangement 18 by a bearing arrangement 40, which will be explained in greater detail below. When an actuating process is executed, the two actuator components 38, 42 can be shifted with respect to each other in a direction parallel to the axis of rotation A as a result of the fact that they are in thread-like or ramp-like engagement with each other; thus, when they are rotated relative to each other, they are also displaced axially with respect to each other. However, the actuator component 42 could also be designed as a slave cylinder, in which the actuator component 38 can slide as a slave piston. It is possible to use a wide variety of actuator mechanisms here.

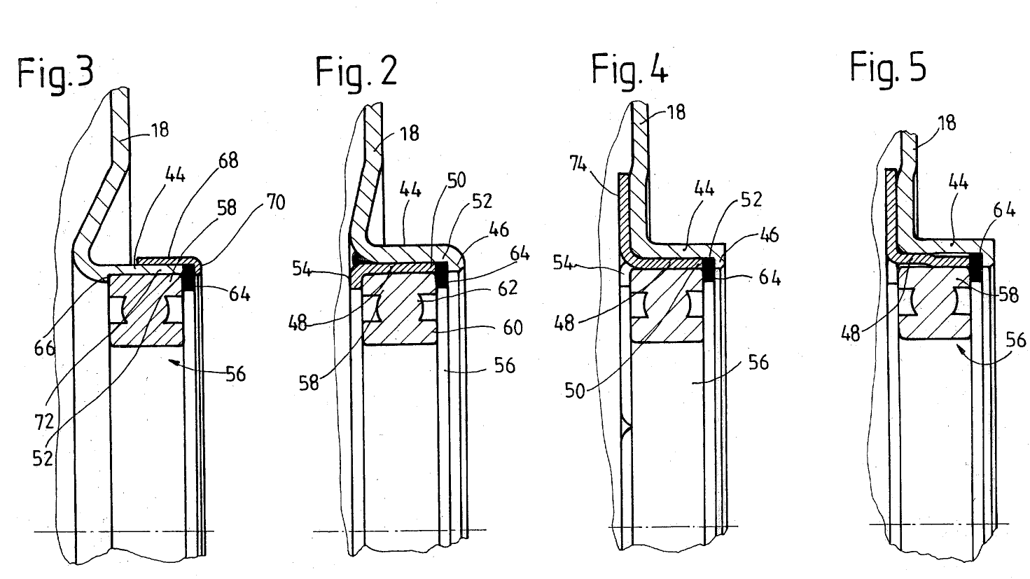

The bearing arrangement 40 shown in FIG. 1 is illustrated in greater detail in FIG. 2. In FIG. 2, we can see the housing arrangement 18, which has a circumferential shoulder 44, preferably ring-like, in its radially inner end area, this shoulder extending essentially in the axial direction. This shoulder has an inward-projecting area 46 on its axially free end. A ring-like retaining element 48 made of sheet metal is pushed into the shoulder 44 and is permanently connected to the housing arrangement 18 by welding, pressing, or some other suitable method. An axial end area 50 of the retaining element 48 is a certain axial distance away from the inward-projecting area 46, so that here an intermediate space 52 is created. At the other axial end, the retaining element 48 forms a radially inward-extending support projection area 54. When the system shown in FIG. 1 is assembled, the actuating mechanism 28, along with the roller bearing 56 of the bearing arrangement 40 already mounted in it, is introduced axially into the shoulder 44, i.e., into the retaining element 48 in that shoulder. An outer bearing ring 58 comes to rest against the projecting area 54, so that the entire bearing 56, which is supported by its inner bearing ring 60 on the actuator mechanism 28, and which has spherical or needle-like rolling elements 62, arrives in a defined axial position. Then, a locking ring 64 can be inserted into the intermediate space 52 to hold the bearing 56 in place in the other axial direction.

In this way, the bearing 56, which forms the essential component of the bearing arrangement 40, is held in position on the housing arrangement 18 in both axial directions, so that, from the very beginning, the actuator mechanism 28, which carries the bearing 56, occupies a defined position with respect to the housing arrangement 18 and thus with respect to the entire friction clutch 10.

It is obvious that, like the shoulder 44 and the projecting area 46, the retaining element 48 does not have to be designed as a completely continuous ring; on the contrary, it can have individual circumferential segments in the projecting area 54, for example, or it can have individual circumferential segments which are inserted into the shoulder 44, whereas the projecting area 54 is then designed as a continuous ring. This also pertains to the design variants described below, in which a similar type of retaining element 48 is present.

FIG. 3 shows a modification in which a retaining element is not used. Instead, a step-like projection 66 is formed on the shoulder 44 of the housing arrangement 18; this projection forms the stop for the outer bearing ring 58. On the other side, the locking ring 64 is again provided to hold the bearing 56 axially in place. This step-like projection 66 can be obtained by stamping, for example, or by a machining process.

It can also be seen that, to allow the formation of the step-like projection 66, the shoulder 44 no longer has an inward-projecting area; instead, a separate slip-over element 68 is provided, which is set down externally onto the shoulder 44 and is then welded, clamped, or attached in some other way to it; this slip-over element has a radially inward-projecting area 70, which works together with the axial end 72 of the shoulder 44 to form the opening 52 for the locking ring.

In the case of the embodiment shown in FIG. 4, an insertable retaining element 48 is again present, but it now has a plurality of radially outward-extending tongues 74, extending in the direction opposite the projecting area 54. The insert part 48 can be attached to the housing 18 by spot welding in the area of these tongues. Otherwise, this embodiment is essentially the same as that shown in FIG. 2.

The embodiment shown in FIG. 5 corresponds essentially to that according to FIG. 4. It can be seen, however, that the area of the retaining element 48 which is pushed into the shoulder 44 is offset slightly to provide an elastic fit for the outer ring 58 of the bearing 56.

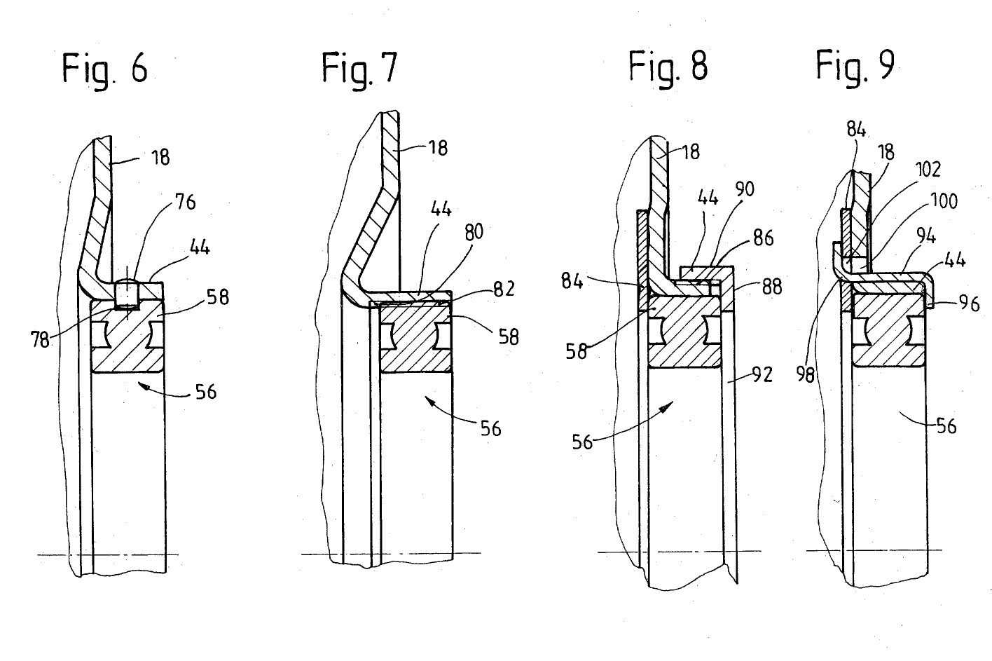

FIG. 6 shows an embodiment in which pass-through openings, in each of which a fastening pin 76 is inserted, are provided in the essentially axially oriented shoulder 44 of the housing arrangement 18. These pins can be held in place in the shoulder 44 by a threaded engagement, by press-fitting, by welding, or the like. A groove 78, which preferably extends continuously in the circumferential direction, is provided in the outer bearing ring 58; the pins 76 engage with essentially no axial play in this groove and thus ensure that the bearing 56 is held in place with respect to the housing arrangement 18.

In the embodiment shown in FIG. 7, the essentially axially oriented shoulder of the housing arrangement 18 is provided with an internal thread 80. In a corresponding manner, an external thread 82 is provided on the outer bearing ring 58, so that the bearing 56 is held in a defined manner on the housing arrangement 18 by the engagement between the threads. The axial positioning of the bearing 56 can be predetermined here, for example, by the end point of the external thread 80. It is also possible to secure the bearing 56 permanently to the shoulder 44 by the use of an adhesive after the two parts have been screwed together.

FIG. 8 shows an embodiment in which a retaining element 84, designed in the form of, for example, a ring-shaped disk, is attached to the housing arrangement 18 by welding, for example; the radially inner area of this retaining element 84 extends radially inward beyond the inner circumferential surface of the shoulder 44. Thus a stop is provided for the outer bearing ring 58 in one axial direction. The shoulder 44 is designed in this case with an external thread 86. Another sleeve-like retaining element 88 has an internal thread 90 in an axially oriented area and has a radially inward-extending flange-like shoulder 92, which forms a surface which supports the bearing 56 in the other axial direction.

In FIG. 9, the retaining element 84 already shown in FIG. 8 is attached to the housing arrangement 18 by welding, for example. An additional ring-like retaining element 94 is provided; a radially inward-extending shoulder 96 of this element holds the bearing 56 in place axially and has tongue-like sections 98 which pass through the openings 100, 102 in the housing arrangement 18 and in the retaining element 84 and thus grip behind the retaining element 84. These tongues 98 can be bent over radially, either in the inward or outward direction, after they have been passed axially through the openings 100, 102, or they can arrive in the position shown in FIG. 9 by a latching type of action.

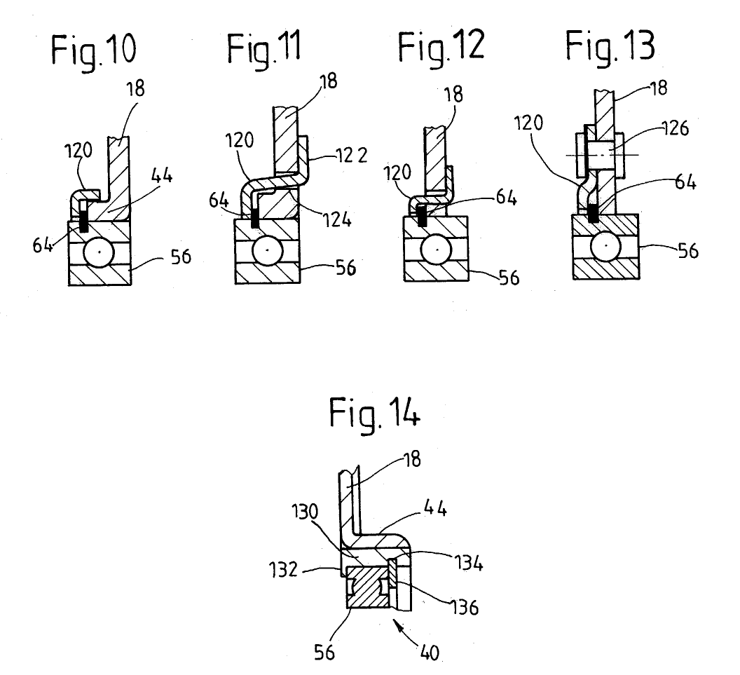

In the embodiment shown in FIG. 10, a locking ring 64 is inserted into a circumferential groove in the outside circumference of the bearing 56, i.e., in the outer ring of this bearing. An axially free end of the shoulder 44 of the housing arrangement 18 rests against this locking ring 64. A retaining ring 120 with an approximately L-shaped cross section is pushed from the outside over the shoulder 44 and rests with its radially inward-extending sidepiece against the other axial side of the locking ring 64. The retaining ring 120 can be attached to the housing arrangement 18 by pressing, welding, brazing, bonding with an adhesive, etc. Because the housing arrangement 18 rests with its axial shoulder 44 on the bearing 56 in this embodiment also, a comparatively large contact area is obtained here.

In the embodiment shown in FIG. 11, the tongue sections 122 of the retaining element 120 pass through openings 124 in the housing arrangement 18; these tongue sections 122 are bent over on the other axial side of the housing arrangement 18, that is, on the axial side facing away from the locking ring 64, to hold the components axially together.

FIG. 12 shows an embodiment in which it is not the axial shoulder 44 of the housing arrangement 18 which rests on the bearing 56, but rather an inner end surface, the width of which is essentially the same in this area as the thickness of the material out of which the housing arrangement 18 is made. Otherwise, the embodiment shown here is the same as that of FIG. 11.

In the embodiment shown in FIG. 13, the ring-shaped retaining element 120 is permanently connected to the housing arrangement 18 in the radially inner area of the housing by several riveting bolts 126. Here, too, an inner end surface of the housing arrangement 18 rests on the bearing 56.

FIG. 14 shows an embodiment in which an insert element 130 is inserted into the axial shoulder 44 of the housing arrangement 18. On one axial end, this element has a projection 132 in the form of, for example, a ring, which forms an axial stop for the bearing 56. On the other axial end, a ring-shaped groove 134 is formed in the insert element 130, into which groove a locking ring 136 is inserted. The bearing 56 is thus again held axially in place in this way with respect to the insert element 130. The insert element 130 is permanently connected in turn to the housing arrangement 18 by welding, for example, or by the use of an adhesive, or by press-fitting. An essential advantage of this embodiment is that various sizes of bearings of the same type can be inserted into the same housing arrangement 18; the only step to be taken to adapt bearings of different diameters to fit the housing is to select appropriately designed insert elements 130. These insert elements 130 are preferably made of thermally insulating material to prevent the transfer of heat between the housing arrangement 18 and the bearing 56 as much as possible.

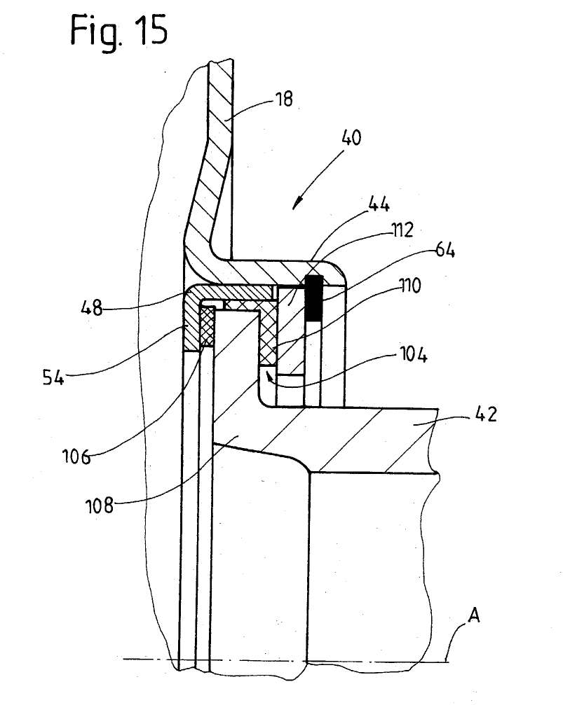

FIG. 15 shows an embodiment in which the bearing arrangement 40 comprises a sliding bearing, designated 104 overall. This bearing has a first, ring-like sliding bearing element 106, which is provided on one axial side of a flange-like projection 108 of the actuator part 42. The radial part of a second sliding bearing element 110 with an L-shaped cross section rests on the other axial side of the shoulder 108, whereas the sidepiece of the “L” which extends essentially in the axial direction rests against an outer circumferential surface of this shoulder 108. A retaining element 48 is again inserted into the shoulder 44 of the housing arrangement 18; the radially inward-projecting area 54 of this insert part defines the axial positioning in one direction, the first sliding bearing element 106 being supported on the projecting area 54. The second sliding bearing element 110 is supported by way of a support ring 112 on a locking ring 64, which is inserted into an inner circumferential groove in the shoulder 44.

In this embodiment as well, a defined axial positioning of the bearing arrangement 40 and thus also of the actuator part 42 with respect to the housing arrangement 18 is provided. Because the insertable retaining element 48 is again permanently connected by welding, for example, to the housing arrangement 18, defined contact areas are present here, in which sliding friction is produced by the use of the bearing elements 106, 110.

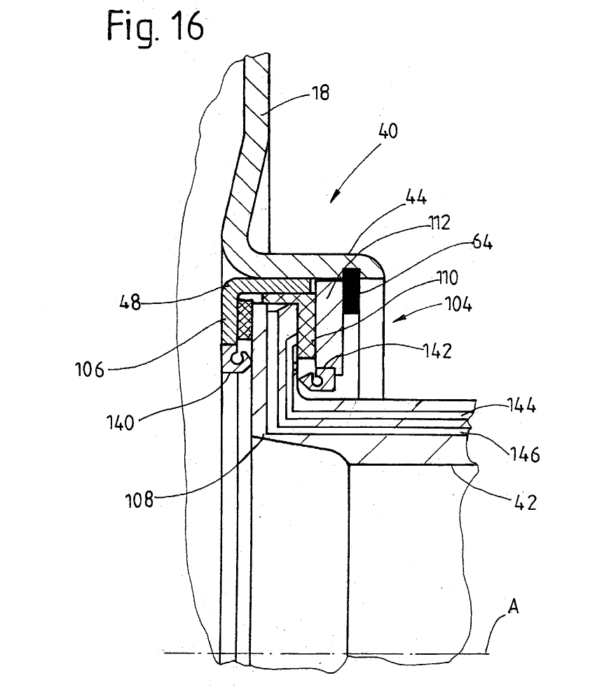

FIG. 16 shows a variant of the previous embodiment in which the bearing arrangement 40 is lubricated. It can be seen that ring-like sealing elements 140, 142 are provided in the inner circumferential area of the insertable retaining element 48, that is, radially inside the sliding bearing element 106 and on the radially inner area of the support ring 112, i.e., radially inside the sliding bearing element 110. These sealing elements 140, 142 have sealing lip areas which rest on the radially outward-extending, flange-like projection 108, which is between the sliding bearing elements 106, 110. By the use of these two sealing elements 140, 142 and in cooperation with the insert part 48, with the sliding bearing element 110, and with the shoulder 44 of the housing arrangement 18, an essentially lubricant-tight encapsulation of the sliding bearing arrangement 104 is therefore obtained. Lubricant can be introduced into, or removed again from, this encapsulated space via two lubricant channels 144, 146, passing through the actuator part 42, so that, for example, by connecting these channels to the lubricant circuit of the transmission, lubricant can also be circulated in the area of the bearing arrangement 40. Thus, a sliding bearing with very low-friction can be obtained, in which, because of the cooling action of the circulating lubricant such as a transmission oil, it is possible simultaneously to prevent overheating. It is obvious that the channels 144, 146 can also lead to other areas of the encapsulated space; for example, they can lead to areas which are not covered directly by a sliding bearing element 106, 110, such as the space located between the sealing element 142 and the radially inner area of the sliding bearing element 110.

It should also be mentioned in regard to the embodiments shown in FIGS. 15 and 16 that the sliding bearing elements designated there by the reference numbers 106 and 110 can be held in place nonrotatably on, for example, the actuator part 42, namely, on the flange-like projection 108 of the actuator part, to achieve defined friction conditions; this can be done by the use of an adhesive, for example, by riveting, or by some other suitable method, so that a sliding movement in contact with the insert part 48 or the support ring 112 is possible. The opposite arrangement, in which the sliding bearing elements 106, 110 are held on the components 48 and 112, respectively, and thus move with sliding friction on the flange-like projection 108, is also possible.

The bearing arrangement to be provided for the force-exerting arrangement 36 can also be designed in the way described above. The design of the bearing arrangement according to the invention can be used when the friction clutch is not designed as a dual clutch but rather as a simple clutch.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

We claim:

1. A friction clutch comprising:
a housing having an axis of rotation;
pressure plate connected to said housing for rotation in common about said axis;
a force exerting arrangement supported against the housing and the pressure plate;
an actuator mechanism which acts on said force exerting arrangement to load said pressure plate axially with respect to said housing; and
a bearing arrangement for supporting said actuator mechanism axially with respect to said housing so that said actuator mechanism is prevented from moving in either of two axial directions with respect to said housing.

2. A friction clutch as in claim 1 further comprising a retaining element which cooperates with said housing to form an opening, and a locking element which is received in said opening to support said bearing arrangement in one axial direction with respect to said housing.

3. A friction clutch as in claim 2 wherein said retaining element supports the bearing arrangement in the other axial direction with respect to said housing.

4. A friction clutch as in claim 3 wherein said retaining element is formed with a support section which supports the bearing arrangement in the other axial direction with respect to the housing.

5. A friction clutch as in claim 1 further comprising a plurality of pins which support said bearing arrangement axially with respect to said housing both axial directions.

6. A friction clutch as in claim 1 wherein said bearing arrangement comprises a bearing component formed with a thread which engages a thread formed on said housing.

7. A friction clutch as in claim 1 further comprising
a first retaining element fixed to said housing and supporting said bearing arrangement in a first axial direction; and
a second retaining element fixed to said housing and supporting said bearing arrangement in a second axial direction.

8. A friction clutch as in claim 7 wherein at least one of said retaining elements is formed with a thread which engages a thread formed on said housing.

9. A friction clutch as in claim 7 wherein one of said retaining elements is latched to said housing.

10. A friction clutch as in claim 9 wherein one of said retaining elements is formed with retaining tongues which extend behind the other retaining element.

11. A friction clutch as in claim 7 wherein said bearing arrangement comprises a first sliding bearing element supported axially on the first retaining element and a second sliding bearing element supported axially on the second retaining element.

12. A friction clutch as in claim 11 wherein at least one of said sliding bearing elements comprises a radial support area.

13. A friction clutch as in claim 11 wherein said bearing arrangement further comprises a lubricant tight encapsulation of said first and second bearing elements.

14. A friction clutch as in claim 1 further comprising
a retaining element which is permanently axially connected to said housing, and
a locking element provided on said bearing arrangement, said locking element having a first axial side which is supported against said housing and a second axial side which is supported against said retaining element.

15. A friction clutch as in claim 14 wherein said retaining element is connected to said housing by one of riveting, welding, brazing, adhesive bonding, deformation, and press fitting.

16. A friction clutch as in claim 1 further comprising an insert element which is permanently attached to the housing and supports said bearing arrangement in two axial directions.

17. A friction clutch as in claim 16 wherein said insert element comprises an axial stop which supports said bearing arrangement in a first axial direction and a locking element which supports the bearing arrangement in a second axial direction.

18. A friction clutch as in claim 1 wherein said friction clutch is a dual clutch having a first clutch area and a second clutch area, each said clutch area comprising a pressure plate and a force-exerting arrangement.
